(19) United States
(12) Patent Application Publication
(10) Pub. No.: US 2021/0245783 A1
(43) Pub. Date: Aug. 12, 2021

(54) CONTROL DEVICE OF AUTOMATED DRIVING VEHICLE

(71) Applicant: Toyota Jidosha Kabushiki Kaisha, Toyota-shi Aichi-ken (JP)

(72) Inventors: Katsuhiro Sakai, Kawasaki-shi, Kanagawa-ken (JP); Kentaro Ichikawa, Sunto-gun, Shizuoka-ken (JP); Akihide Tachibana, Chiyoda-ku, Tokyo-to (JP); Hiroshi Nakamura, Chiyoda-ku, Tokyo-to (JP); Taisuke Sugaiwa, Chofu-shi, Tokyo-to (JP)

(21) Appl. No.: 17/152,240

(22) Filed: Jan. 19, 2021

(30) Foreign Application Priority Data
Feb. 7, 2020 (JP) 2020-019905

(51) Int. Cl. B60W 60/00

(52) U.S. Cl. CPC B60W 60/0017; B60W 60/00253; B60W 2554/4029; B60W 2050/0095; B60W 2554/802; B60W 2420/42; B60W 2554/4041

(57) ABSTRACT

A control device of an automated driving vehicle is configured to perform a recognition process, a search process, and a selection process. The recognition processing is a process for recognizing that the vehicle has entered a boarding area where an occupant gets off or gets on. The search process is a process of searching for a guide in the boarding area when the vehicle enters the boarding area. The selection process is a process, as the operation of the vehicle in the boarding area, in which a first operation mode is selected when the guide is not found, and a second operation mode is selected when the guide is found. The control device is configured to mitigate safety standards of an active safety system which avoids a collision between the vehicle and surrounding objects in the second operation mode, as compared with the first operation mode.

### CROSS-REFERENCE TO RELATED APPLICATION

The present application claims priority under 35 U.S.C. § 119 to Japanese Patent Application No. 2020-019905, filed Feb. 7, 2020. The contents of this application are incorporated herein by reference in their entirety.

### TECHNICAL FIELD

Embodiments in the present disclosure relate to a control device for an automated driving vehicle.

### BACKGROUND

WO2019/065696A1 teaches an automated driving technique for stopping the vehicle at an appropriate position by a control device of an automated driving vehicle communicating with a server device via a network and obtaining a stop position at which the vehicle should stop from map data stored in a storage unit of the server device.

### SUMMARY

Facilities, such as stations, airports, and hotels, are provided with a boarding area in which occupants get on and off. Since many vehicles including automated driving vehicles are concentrated in the boarding area, the boarding are often congested with vehicles and people. In the case of the automated driving vehicle to which the above-described automated driving technique is applied, in the facility where the boarding area is provided, the movement of the vehicle is controlled so as to stop the vehicle at the target stop position set in the boarding area.

In order to ensure safety during automatic operation, the automated driving vehicle is equipped with an active safety system for avoiding collision with surrounding objects. In boarding areas congested with vehicles and people, the active safety system is easy to operate for the vehicles and people. Frequent or intense actuation of the active safety system will block the movement of the vehicle and inhibit smooth movement of the vehicle to the proper stop position.

An example in the present disclosure has been made in view of the above-mentioned problems, and an object thereof is to provide a control device capable of smoothly moving an automated driving vehicle to a proper stop position in a boarding area in which an occupant gets off or gets on.

A control device of an automated driving vehicle according to an example in the present disclosure comprises a processor to execute a program; and a memory to store the program. The program, when the program executed by the processor, performs a recognition process, a search process, and a selection process. The recognition processing is a process for recognizing that the vehicle has entered a boarding area where an occupant gets off or gets on. The search process is a process of searching for a guide in the boarding area when the vehicle enters the boarding area. The selection process is a process, as the operation of the vehicle in the boarding area, in which a first operation mode is selected when the guide is not found, and a second operation mode is selected when the guide is found. The program is configured to mitigate safety standards of an active safety system which avoids a collision between the vehicle and surrounding objects in the second operation mode, as compared with the first operation mode.

In the boarding area, vehicles or person may be conducted by a guide. In that case, as compared with the case where there is no guide, the traffic of the vehicles and the persons is arranged, and it is easy for the automated driving vehicle to predict the movement of the surrounding objects. Thus, it is possible to mitigate the safety standards of the active safety system when a guide is found, as compared with the case when no guide is found. By mitigating the safety standards of the active safety system, frequency and intensity of the operation of the active safety system may be suppressed, and smooth movement of the vehicle to a proper stop position may be realized.

The program may perform, in the second operation mode, a process for running or stopping the vehicle in accordance with the instruction information obtained from the guide. When there is the guide in the boarding area, the automated driving vehicle may be moved to a proper stop position in the crowded boarding area by following an instruction from the guide instead of relying only on map information or sensor information.

The program may perform, in the second operation mode, a process for generating a target trajectory to cause the vehicle to follow the guide. When there is a guide in the boarding area, it is possible for the guide to conduct the automated driving vehicle by generating the target trajectory so as cause the automatic operation vehicle to follow the guide. Then, by the guidance of the guide, it is possible to move the automated driving vehicle to the proper stop position.

The program may perform, in the second operation mode, a process for reducing the limiting distance to the vehicle at which the active safety system operates for a surrounding object, as compared with the first operation mode. Reducing the limiting distance at which the active safety system operates for the surrounding object when there is the guide in the boarding area is one aspect of mitigating the safety standards of the active safety system. By reducing the limiting distance at which the active safety system operates, it is possible to approach the surrounding object closely or to pass through a side of the surrounding object with a small margin. Thereby, the automated driving vehicle is prevented from stopping or decelerating due to the operation of the active safety system. Therefore, it is possible to realize a smooth movement of the vehicle to the proper stop position.

The program may perform a process for reducing a time-to-collision for the active safety system to operate relative to the surrounding object in the second operation mode, as compared with the first operation mode. Reducing the time-to-collision for the active safety system to operate relative to the surrounding object when there is the guide in the boarding area is one aspect of mitigating the safety standards of the active safety system. By reducing the time-to-collision for the active safety system to operate, it becomes possible to approach to the vicinity of the surrounding object without greatly decreasing the speed. Thereby, the vehicle is prevented from stopping or decelerating due to the operation of the active safety system. Therefore, a smooth movement to the proper stop position is realized.

The program may perform, in the second operation mode, a process for making the limiting distance at which the active safety system operates for the guide shorter than the limiting distance at which the active safety system operates for the object other than the guide. It is one aspect of mitigating the safety standards of an active safety system to make the limiting distance at which the active safety system operates for the guide shorter than that for the object other than the guide. By shortening the limiting distance at which the active safety system operates for the guide, it is possible to approach the guide closely or to pass through a side of the guide with a small margin. It is possible to prevent the automated driving vehicle from stopping or decelerating due to the operation of the active safety system during guidance by the guide. Therefore, it is possible to realize a smooth movement to the proper stop position.

The program may perform, in the second operation mode, a process for making the time-to-collision for the active safety system to operate for the guide shorter than the time-to-collision for the active safety system to operate for the object other than the guide. It is one aspect of mitigating the safety standards of the active safety system to make the time-to-collision for the active safety system to operate for the guide shorter than that for the object other than the guide. By shortening the time-to-collision for the active safety system to operate for the guide, it becomes possible to approach to the vicinity of the guide without greatly decreasing the speed. It is possible to prevent the automated driving vehicle from stopping or decelerating due to the operation of the active safety system during guidance by the guide. Thereby, it is possible to realize a smooth movement to the proper stop position.

The program may perform, in the second operation mode, a process for excluding the guide from the target objects for which the active safety system operates. The exclusion of the guide from the target objects is one aspect of mitigating the safety standards of the active safety system. By the exclusion of the guide from the target objects of the active safety system, the active safety system becomes not to operate for the guide. Therefore, it is possible to prevent the automated driving vehicle from stopping or decelerating due to the operation of the active safety system during the guidance by the guide, and to realize a smooth movement to the proper stop position.

The program may perform, in the search process, in the second operation mode, a process for obtaining an image of a person existing around the vehicle, and searching for the guide by an image recognition process for the image. When the guide is in characteristic clothes or performs characteristic actions, the guide is detected among the persons existing around the vehicle by the image recognition process.

The program may perform, in the search process, in the second operation mode, a process for obtaining the voice emitted around the vehicle and search for the guide by the voice recognition process for the voice. When the guide is speaking a characteristic word, the guide is detected among the persons existing around the vehicle by the voice recognition process.

The program may perform a process for, as the operation of the vehicle on departure from the boarding area, selecting the first operation mode when the guide is not found and selecting the second operation mode when the guide is found. By mitigating the safety standards of the active safety system when the guide is found at the departure of the automated driving vehicle from the boarding area, the frequency of the operation of the active safety system and the intensity of the operation is suppressed, and the smooth departure from the boarding area is realized.

As described above, according to the control device of the automated driving vehicle according to the example in the present disclosure, when the guide is found in the boarding area, as compared with the case where the guide is not found, the safety standards of the active safety system are mitigated, so that the frequency of the operation of the active safety system and the intensity of the operation may be suppressed, and smooth movement of the vehicle to the proper stop position may be realized.

### BRIEF DESCRIPTION OF DRAWINGS

FIG. 1 is a diagram illustrating an outline of an embodiment in the present disclosure;

FIG. 2 is a diagram illustrating a configuration of an automated driving vehicle according to the embodiment in the present disclosure;

FIG. 3 is a diagram illustrating a function of a control device according to the embodiment in the present disclosure;

FIG. 4 is a flowchart illustrating a determination procedure of a switching of an operation mode when entering a boarding area;

FIG. 5 is a flowchart illustrating a determination procedure of a switching of the operation mode when leaving from the boarding area;

FIG. 6 is a diagram illustrating a first embodiment of mitigating safety standards of an active safety system;

FIG. 7 is a diagram illustrating a second embodiment of mitigating the safety standards of the active safety system.

### DESCRIPTION of EMBODIMENTS

Embodiments in the present disclosure will be described with reference to drawings. However, even if number (such as number, value, amount, quantity, and range) of the each elements are referred in the following embodiments, the embodiments in the present disclosure are not limited to the number, unless specifically stated or obviously identified in principle. In addition, the structure, steps, or the like described in the following embodiments is not essential to the embodiments in the present disclosure unless specifically stated or clearly identified in principle.

### 1. Outline of Embodiments

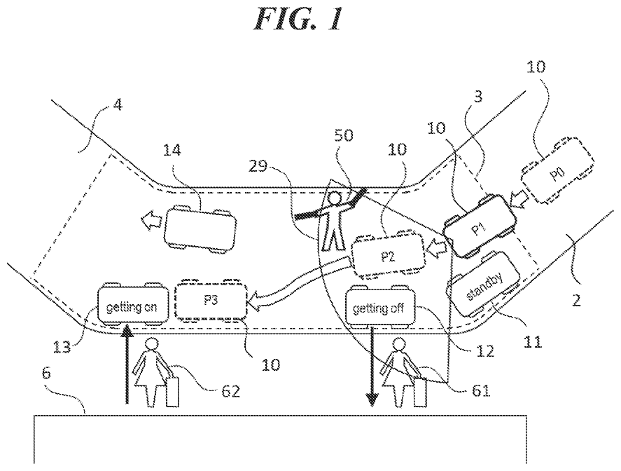

First, the summary of the embodiment in the present disclosure will be described with reference to FIG. 1. A facility 6, such as a station, an airport, and a hotel, is provided with a boarding area 3 in which a user 61 who uses the facility 6 gets off from a vehicle and a user 62 who uses the facility 6 gets on a vehicle. In map information referred to by an automated driving vehicle, the position of the facility 6 is registered, and the position and the range of the boarding area 3 are registered. Even if the actual boarding area is not clear, the position and the range of the boarding area 3 are clearly defined on the map. The boarding area 3 may be provided in contact with a part of a public road such as a station and an airport, or may be provided in a site of the facility 6 such as a hotel. In an example illustrated in FIG. 1, the boarding area 3 is provided on the site of the facility 6. An approach route 2 for guiding a vehicle from a public road to the boarding area 3 and an exit route 4 for guiding a vehicle from the boarding area 3 to a public road are connected to the boarding area 3. The approach route 2 and the exit route 4 are also registered in the map information.

A vehicle 10 to which a control device according to the present embodiment is applied is an automated driving vehicle capable of automated driving using the map information and sensor information. When the automated driving vehicle 10 runs the facility 6 as a destination, a target stop position is set on the boarding area 3 in front of the facility 6. However, there is a case where the boarding area 3 is crowded with a large number of vehicles, such as a vehicle 11 in standby, a vehicle 12 from which a user 61 is getting off, a vehicle 13 in which a user 62 is getting on, a the vehicle 14 running in the boarding area 3. In some cases, a person who get off a vehicle or a person who will get on a vehicle walks in the boarding area 3. Therefore, the control device of the automated driving vehicle is required to drive the automated driving vehicle 10 to the target stop position in the boarding area 3 while avoiding the other vehicles 11, 12, 13, 14 and the persons.

The automated driving vehicle 10 is provided with an active safety system for avoiding a collision between the automated driving vehicle 10 and a surrounding object. The active safety system is one of advanced safety functions with which the automated driving vehicle 10 is provided. One exemplary active safety system is a PCS (Pre-Crash Safety System). The PCS actuates the brake so as to stop or decelerate the autonomous vehicle 10 in front of a surrounding object when the presence of the surrounding object detected by sensors ceases to meet safety standards for the automated driving 10. As the safety standard for activating the active safety system, a limiting distance between the surrounding object and the automated driving vehicle 10, or a time-to-collision between the surrounding object and the automated driving vehicle 10, is used. Usually, these safety standards are set with a margin to operate reliably in any circumstance, considering a measurement error of relative distance and relative velocity with the surrounding object, and the difficulty of predicting the movement of the surrounding object. Therefore, the active safety system is likely to operate frequently in the boarding area 3 crowded with many vehicles and people.

Frequent actuation of the active safety system will block the movement of the vehicle. However, if the safety standards are simply mitigated, the safety which is most important in the automated driving is not secured. Therefore, attention has been paid to the existence of a guide 50 for guiding vehicles and persons in the boarding area 3. In the case where the guidance of the vehicles or the persons is performed by the guide 50, the traffic of the vehicles or the persons is organized as compared with the case where there is no guide 50. Therefore, it is easy for the automated driving vehicle 10 to predict the movement of the surrounding object. If the prediction accuracy of the movement of the surrounding object is increased, the margin given to the safety standards may be reduced. In other words, the safety standards of the active safety system may be mitigated when the guide 50 is found, as compared with when the guide 50 is not found.

For the above reasons, the control device according to the present embodiment, when the automated driving vehicle 10 enters the boarding area 3, switches the selection of operation mode used for driving the vehicle 10 in the boarding area 3 between the cases where the guide 50 is not found and where the guide 50 is found. The operation mode selected when the guide 50 is not found is a first operation mode, which is the default operation mode normally used on roads other than the boarding area 3. The operation mode selected when the guide 50 is found is a second operation mode. In the second operation mode, the safety standards of the active safety system are mitigated as compared with the first operation mode. When the automated driving vehicle 10 is operated in the second operation mode, the mitigation of the safety standards of the active safety system reduces frequency and intensity of operation of the active safety system and realizes smooth movement of the vehicle to the proper stop position.

In the first operation mode, which is a normal operation mode, a target trajectory of the automated driving vehicle 10 is generated based on the map information and position and speed information of the surrounding object obtained by the sensor. In the second operation mode selected only when the guide 50 is found, an instruction from the guide 50 may be added to the information for generating the target trajectory. In addition, the target trajectory is defined by a coordinate column defining a path to be passed by the automated driving vehicle 10 on a plane in which the automated driving vehicle 10 is located, and speed and acceleration of the automated driving vehicle 10 at each coordinate.

In FIG. 1, one example of the operation of the automated driving vehicle 10 in the second operation mode is illustrated. When the automated driving vehicle 10 is moved, from a position P0 on the approach route 2 in front of the boarding area 3, to a position P1 in the boarding area 3, the control device searches the guide 50 in a visual field range 29 of camera. As a more specific example, the control device performs image recognition process for the image obtained by the camera, and detects the guide 50 from the image in the visual field range 29 by extracting the amount of characteristics such as clothes. If the guide 50 is detected, the control device switches the operation mode from the first operation mode to the second operation mode.

In the second operation mode, the control device, for example, controls the operation of the automated driving vehicle 10 in accordance with a stop instruction and a forward instruction directed by the guide 50. When the forward instruction is given at the position P1, the control device generates the target trajectory from the position P1 to the target stop position P3 by the same method as in the first operation mode, and causes the automated driving vehicle 10 to follow the target trajectory. If the stop instruction is given by the guide 50 when the automated driving vehicle 10 comes to a position P2, the control device stops the automated driving vehicle 10 once at the position P2. Then, waiting at the position P2 until the forward instruction is given again, when the forward instruction is given, the control device regenerates the target trajectory from the position P2 to the target stop position P3, and causes the automated driving vehicle 10 to follow the regenerated target trajectory. By operating the automated driving vehicle 10 in accordance with the instruction given to the automated driving vehicle 10 by the guide 50, it is possible to facilitate traffic in the crowded boarding area. During the operation in the second operation mode, the safety standards of the active safety system have been mitigated. Therefore, in the example illustrated in FIG. 1, the automated driving vehicle 10 is prevented form stopping in response to the vehicle 12 in getting off, or stopping in front of the target stop position P3 in response to the vehicle 13 in getting on.

### 2. Configuration of Automated Driving Vehicle

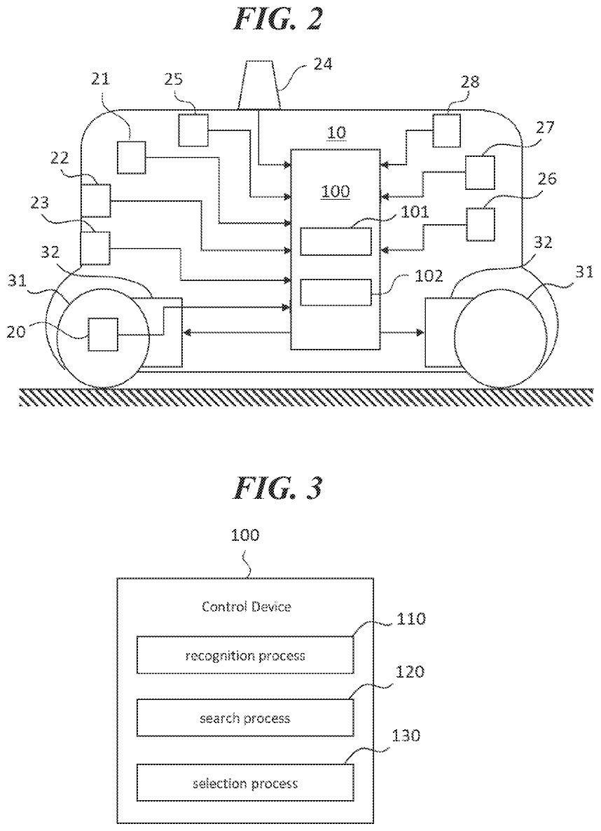

Next, a configuration of the automated driving vehicle 10 to which the control according to the embodiment in the present disclosure is applicable will be described with reference to FIG. 2. The automated driving vehicle 10 is provided with a number of sensors for obtaining information necessary for realizing automatic traveling. For example, a vehicle sensor, such as a wheel speed sensor 20 and an acceleration sensor 21, for obtaining information on the motion state of the vehicle is mounted on the automated driving vehicle 10. Further, an autonomous sensor, such as a camera 22, a millimeter-wave radar 23, and a LIDAR 24, for obtaining information on surrounding environment of the vehicle is mounted on the automated driving vehicle 10. Further, the automated driving vehicle 10 is provided with a GPS unit 25 for detecting the position of the vehicle on the map, a mobile communication unit 26 for performing mobile communication with a server on the Internet, a radio communication unit 27 for performing radio communication by Wi-Fi (registered trademark) with surrounding persons, objects, or facilities, or the like. A microphone 28 for picking up sound around the vehicle is also mounted on the automated driving vehicle 10.

The above-described sensors and communication units are connected to the control device 100 by an in-vehicle network such as a CAN (controller Area Network), for example. The control device 100 is configured by one or more ECUs (Electronic Control Unit) and includes at least one processor 101 and at least one memory 102. The memory 102 described herein also includes storage. A program for automated driving is stored in the memory 102. The map information for automated driving stored in the memory 102 in the form of a database or is retrieved from a database in the server and temporarily stored in the memory 102.

The automated driving vehicle 10 is provided with an actuators 32 for operating wheels 31. The actuators 32 includes a steering actuator for steering the wheels 31, a driving actuator for exerting a driving force on the wheels 31, and a braking actuator for exerting a braking force on the wheels 31. The control device 100 controls the operation of the actuators 32 to cause the automated driving vehicle 10 to follow the target trajectory. Also, when the active safety system is in operation, the control device 100 controls the operation of the actuators 32 to avoid a collision between the automated driving vehicle 10 and the surrounding object. The active safety system is one of the functions of the control device 100 implemented by the processor 101 executing a dedicated program stored in the memory 102.

### 3. Function of Control Device

Next, the function of the control device 100 will be described with reference to FIG. 3. The control device 100 includes a recognition processing unit 110, a search processing unit 120, and a selection processing unit 130 as illustrated in a block in FIG. 3. However, these processing units do not exist as a hardware. The control device 100 is programmed to perform the functions illustrated by the blocks in FIG. 3. More specifically, when the program stored in the memory 102 is executed by the processor 101, the processor 101 executes the process related to these processing units. The control device 100 has various functions for automated driving and advanced security in addition to the functions illustrated in the block in FIG. 3. However, since known techniques can be used for the automated driving and the advanced security, their descriptions are omitted in the present disclosure.

The processor 101 as the recognition processing unit 110 executes a recognition process for recognizing that the automated driving vehicle 10 enters the boarding area 3. Since the position and the range of the boarding area 3 is included in the map information, it is possible to determine whether the automated driving vehicle 10 has entered the boarding area 3 by checking the position of the automated driving vehicle 10 obtained by the GPS unit 25 by the position and the range of the boarding area 3. When the boarding area 3 is not included in the map information, for example, information for distinguishing between the inside and the outside of the boarding area 3 may be obtained from the image captured by the camera 22. When radio waves are emitted from the infrastructure facility, it may be determined whether the automated driving vehicle 10 has entered the boarding area 3 from the intensity of the radio waves.

When the automated driving vehicle 10 enters the boarding area 3, the processor 101 as the search processing unit 120 executes a search process for searching the guide 50 in the boarding area 3. In the search process, the image recognition process for the image obtained by the camera 22 is used. Because of the need to be perceived by the surrounding person, the guide 50 is often in characteristic clothes. In addition, in many cases, the guide 50 performs a characteristic action because of the necessity of easily communicating the content of the instruction. When the guide 50 is in the characteristic clothes or performs the characteristic action, the guide 50 is detected from among persons existing around the automated driving vehicle 10 by extracting the amount of characteristics by image recognition process for the image acquired by the camera 22.

As another example of the search process, voice recognition process for the voice acquired by the microphone 28 may be used. In many cases, the guide 50 utters a characteristic word representing the content of the instruction. When the guide 50 utters the characteristic word, the guide 50 is detected from among persons existing around the automated driving vehicle 10 by extracting the amount of characteristics by the voice recognition process for the voice acquired by the microphone 28.

The processor 101 as the selection processing unit 130 executes the selection process. In the selection process, as the operation of the automated driving vehicle 10 in the boarding area 3, the first operation mode which is a normal operation mode is selected when the guide 50 is not found whereas the second operation mode is selected when the guide 50 is found. When the second operation mode is selected, the processor 101 controls the operation of the automated driving vehicle 10 in accordance with the instruction information obtained from the guide 50.

For the simplest example, the content of the instruction included in the instruction information sent from the guide 50 is forward and stop (once stop) as described in the outline. If more complex instructions are to be sent, the instruction information may be include contents of instruction of steering to the right, steering to the left, complete stop, retreat, etc., in addition to forward and once stop. The processor 101 controls the operation of the automated driving vehicle 10 in accordance with instructions directed by the guide 50. For example, when the forward instruction is given, the processor 101 generates the target trajectory from the current position to the target stop position. However, when a stop position different from the initial target stop position is instructed by the guide 50, the processor 101 generates a target trajectory to the stop position instructed by the guide 50. When an instruction to adjust the trajectory (for example, an instruction to turn the trajectory slightly to the left) is directed by the guide 50, the target trajectory is corrected in accordance with the instruction. When an instruction of acceleration or deceleration is directed by the guide 50, the speed profile included in the target trajectory is corrected in accordance with the instruction.

As a method of sending the instruction information from the guide 50 to the automated driving vehicle 10, the image recognition process for the image obtained by the camera 22 is used. However, it is assumed that the action of the guide 50 when guiding vehicles, for example, the manner of swinging a bar or a flag, is determined in advance for each content of the instruction. If the content of the instruction is associated to the action of the guide 50, it is possible to recognize the content of the instruction from the guide 50 to the automated driving vehicle 10 by performing image recognition process for the action of the guide 50 imaged by the camera 22 and extracting the amount of characteristics.

As another method of sending the instruction information from the guide 50 to the automated driving vehicle 10, wireless communication may be used. In this case, it is assumed that the guide 50 is provided with a mobile terminal and the instruction content is input to the mobile terminal. Mobile terminal may be a smart phone or tablet PC. As the radio communication used for transmitting the instruction information, for example, mobile communication, such as, LTE, and 5G, may be used as well as Wi-Fi (registered trademark) or Bluetooth (registered trademark).

As another method of sending the instruction information from the guide 50 to the automated driving vehicle 10, a voice instruction may be used. A microphone of the mobile terminal carried by the guide 50 may be used as the microphone for the voice instruction. Also, the microphone 28 mounted on the automated driving vehicle 10 may be used. However, it is assumed that sounds, such as, key words or phrases, emitted by the guide 50 when guiding a vehicle are predetermined for each content of the instruction. If the content of the instruction content is associated with the voice of the guide 50, it is possible to recognize the content of the instruction from the guide 50 to the automated driving vehicle 10 by performing the voice recognition process on the voice of the guide 50 obtained by the microphone and extracting the amount of characteristics. The method of sending the instruction information by voice may be used in conjunction with the method of sending the instruction information by action.

As another example of the automatic operation in the second operation mode, the processor 101 may generate the target trajectory to cause the automated driving 10 to follow the guide 50. Specifically, the position of the guide 50 is set as the target stop position, and the target stop position is updated each time the guide 50 moves. When the guide 50 is present in the boarding area 3, the automated driving vehicle 10 is guided by the guide 50 by generating the target trajectory so as to cause the automated driving vehicle 10 to follow the guide 50. Then, the automated driving vehicle 10 is moved to the proper stop position by the guidance of the guide 50. At this time, since the safety standards of the active safety system have been mitigated, the actuation of the active safety system relative to the guide 50 is suppressed, and a smooth movement of the automated driving vehicle 10 may be realized.

### 4. Procedure for Determining Operation Mode Switching

The control device 100 in which the function described above is programmed determines the switching of the operation mode in the following procedure, when the automated driving vehicle 10 enters the boarding area 3 and when the automated driving vehicle 10 exits the boarding area 3.

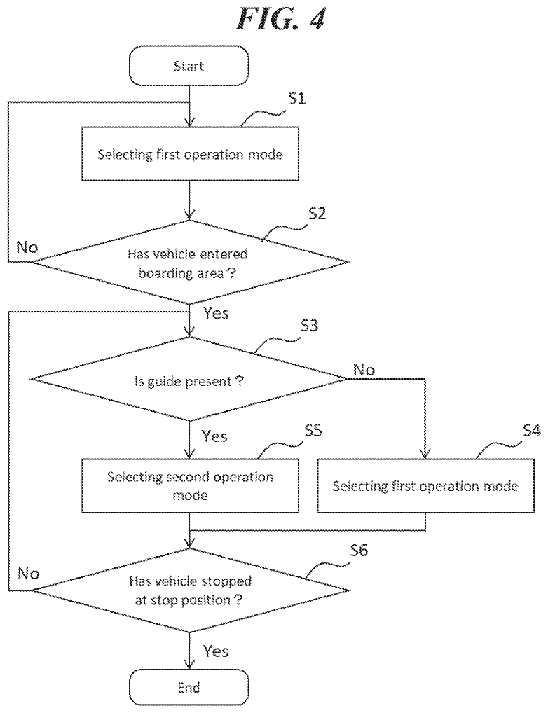

In FIG. 4, the procedure for determination of the switching of the operation mode when the automated driving vehicle 10 enters the boarding area 3 is represented by a flowchart. The procedure illustrated in the flowchart of FIG. 4 is started when the facility 6 is set as a destination of the automated driving vehicle 10 and the target stop position is set in the boarding area 3.

In step S1, the first operation mode which is a normal operation mode is selected as the operation mode when the automated driving vehicle 10 is outside the boarding area 3. In step S2, by the recognition process, it is determined whether the automated driving vehicle 10 has entered the boarding area 3. This determination is performed at a predetermined cycle until the automated driving vehicle 10 enters the boarding area 3. Meanwhile, in step S1, the operation in the first operation mode is continued. When the automated driving vehicle 10 has entered the boarding area 3, the procedure proceeds to step S3.

In step S3, the guide 50 is searched by the search process, and it is determined whether or not the guide 50 is present in the boarding area 3. When the guide 50 is not found in the boarding area 3, the procedure proceeds to step S4. In step S4, the first operation mode is selected as the operation mode of the automated driving vehicle 10. That is, the operation in the first operation mode which is a normal operation mode is continued.

When the guide 50 is found in the boarding area 3, the procedure proceeds to step S5. In step S5, the second operation mode is selected as the operation mode of the automated driving vehicle 10. In the second operation mode, the safety standards of the active safety system are mitigated as compared with the first operation mode. Further, in the second operation mode, the operation of the automated driving vehicle 10 is controlled in accordance with not only the map information and the sensor information but also the instruction information obtained from the guide 50.

In step S6, it is determined whether the automated driving vehicle 10 has stopped at the proper stop position. The proper stop position is the initial target stop position or the stop position directed by the guide 50. The procedure from step S3 to step S6 is repeated until the automated driving vehicle 10 stops at the proper stop position. In the meantime, when the guide 50 is lost or when the guide 50 disappears from the boarding area 3, the first operation mode is selected again as the operation mode of the automated driving vehicle 10. Then, when the automated driving vehicle 10 stops at the proper stop position, the procedure illustrated in the flowchart of FIG. 4 is terminated.

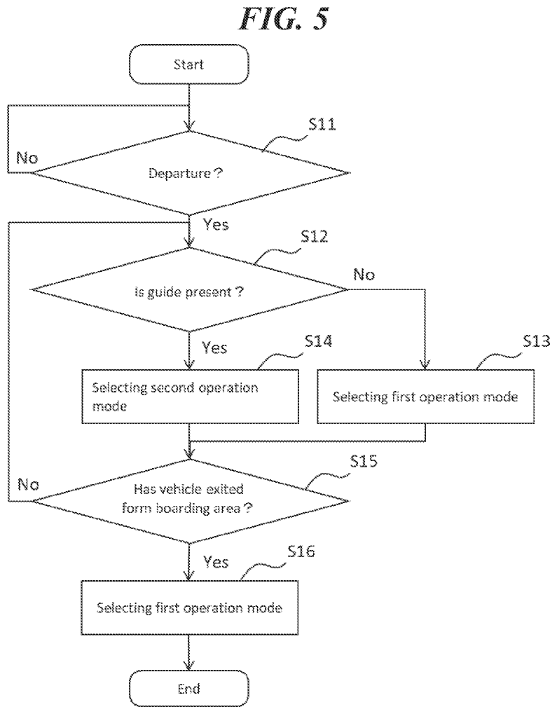

In FIG. 5, the procedure of determination of the switching of the operation mode when the automated driving vehicle 10 exits the boarding area 3 is represented by a flowchart. The procedure illustrated in the flowchart of FIG. 5 is started while the automated driving vehicle 10 is stopped at the stop position in the boarding area 3.

In step S11, it is determined whether or not there is a departure instruction to the automated driving vehicle 10 from the occupant or the server. This determination is performed at a predetermined cycle until the departure instruction is received. When the departure instruction has been received, the procedure proceeds to step S12.

In step S12, the guide 50 is searched by the search process, and it is determined whether or not the guide 50 is present in the boarding area 3. When the guide 50 is not found in the boarding area 3, the procedure proceeds to step S13. In step S13, the first operation mode is selected as the operation mode of the automated driving vehicle 10.

When the guide 50 is found in the boarding area 3, the procedure proceeds to step S14. In step S14, the second operation mode is selected as the operation mode of the automated driving vehicle 10. As in the case of arrival, in departure, the safety standards of the active safety system are mitigated as compared with the first operation mode in the second operation mode. Thereby, the frequency and the intensity of the operation of the active safety system are suppressed, and a smooth departure from the boarding area 3 may be realized. Further, in the second operation mode, the operation of the automated driving vehicle 10 is controlled in accordance with not only the map information and the sensor information but also the instruction information obtained from the guide 50.

In step S15, it is determined whether or not the automated driving vehicle 10 has exited from the boarding area 3. Until the automated driving vehicle 10 has exited form the boarding area 3, the procedure from step S12 to step S15 is repeated. In the meantime, when the guide 50 is lost or when the guide 50 disappears from the boarding area 3, the first operation mode is selected as the operation mode of the automated driving vehicle 10. Then, when the automated driving vehicle 10 has exited from the boarding area 3, the procedure proceeds to step S16. In step S16, the operation mode of the automated driving vehicle 10 is switched to the first operation mode which is a normal operation mode.

### 5. Embodiments of Mitigation of Safety Standards of Active Safety System

As described above, the control device 100 mitigates the safety standards of the active safety system in the second operation mode as compared to the first operation mode. The embodiments of the mitigation of the safety standards of the active safety system by the control device 100 will be described. The control device 100 mitigates the safety standards of the active safety system in any one of the embodiments described below.

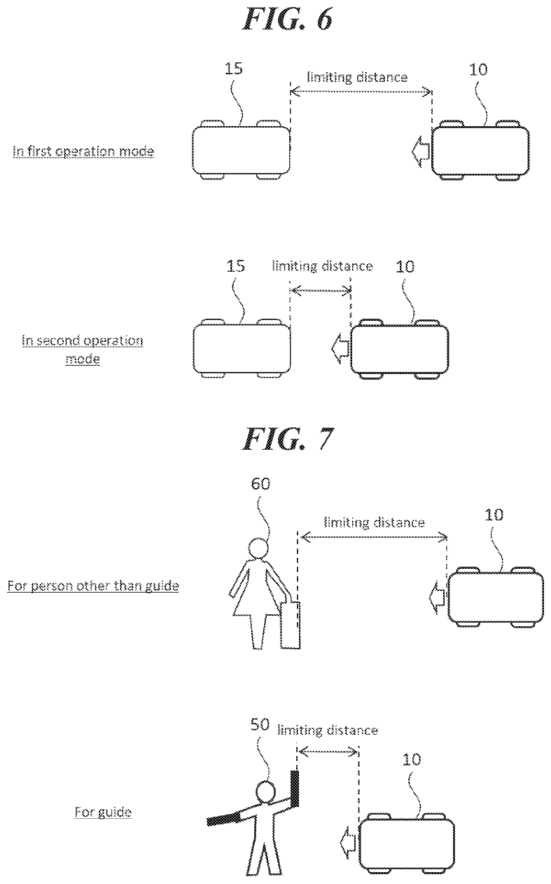

FIG. 6 illustrates a first embodiment of mitigation of the safety standards of the active safety system. In the first embodiment, the control device 100 switches the limiting distance between the automated driving vehicle 10 and the surrounding object (the vehicle ahead of the traveling direction in FIG. 6) 15 to which the active safety system is actuated according to the operation mode. Specifically, the control device 100 makes the limiting distance in the second operation mode shorter than the limiting distance in the first operation mode. By shortening the limiting distance at which the active safety system operates, the automated driving vehicle 10 approaches the surrounding object closely. Although not illustrated, the active safety system also operates on a surrounding object situated on the side of the automated driving vehicle 10. Shortening the limiting distance also makes it possible to pass through the side of the surrounding object with a small margin. If the autonomous vehicle 10 is allowed to come closer to the surrounding objects, the automated driving vehicle 10 is prevented from stopping or decelerating due to the operation of the active safety system.

As a variation of the first embodiment, the limiting distance may be replaced with a time-to-collision at which the active safety system operates relative to the surrounding object 15. That is, the control device 100 may make the time-to-collision in the second operation mode shorter than the time-to-collision in the first operation mode. The time-to-collision (TTC) is an indicator of how many seconds it takes to collide when the current relative speed is maintained. By shortening the time-to-collision, the automated driving vehicle 10 may approach to the vicinity of the surrounding object without significantly decreasing the speed. The automated driving vehicle 10 is prevented from stopping or decelerating due to the operation of the active safety system.

FIG. 7 is a diagram illustrating the second embodiment of mitigating the safety standards of the active safety system. In the second embodiment, the control device 100 switches the limiting distance at which the active safety system operates according to objects only when the second operation mode is selected. Specifically, the control device 100 makes the limiting distance at which the active safety system operates relative to the guide 50 shorter than the limiting distance at which the active safety system operates relative to objects other than the guide (person 60 in FIG. 7). When the first operation mode is selected, such switching of the limiting distance is not performed. By shortening the limiting distance at which the active safety system operates relative to the guide 50, the automated driving vehicle 10 may approach the guide 50 closely. In addition, when passing by the guide 50, it is possible to pass through with a small margin. If the automated driving vehicle 10 becomes possible to approach the guide 50 closely, the autonomous vehicle 10 is prevented from stopping or decelerating due to the actuation of the active safety system during induction by the guide 50.

As a variation of the second embodiment, the limiting distance may be replaced by a time-to-collision for which the active safety system operates. That is, the control device 100 may, in a second operation mode, shorten the time-to-collision for which the active safety system operates for the guide 50 than the time-to-collision for which the active safety system operated for objects other than the guide. By shortening the time-to-collision during which the active safety system is actuated relative to the guide 50, the automated driving vehicle 10 may approach close to the guide 50 without significantly decreasing the speed. Therefore, the automated driving vehicle 10 is prevented from stopping or decelerating due to the operation of the active safety system during induction by the guide 50.

Finally, a third embodiment of the mitigation of the safety standards of the active safety system will be described. In the third embodiment, the control device 100 excludes the guide 50 from the objects for which the active safety system operates. By excluding the guide 50 from the objects for which the active safety system operates, the active safety system becomes not to operate with respect to the guide 50. Thereby, the automated driving vehicle 10 is prevented from stopping or decelerating due to the operation of the active safety system during induction by the guide 50.

What is claimed is:

1. A control device for an automated driving vehicle comprising
a processor to execute a program; and
a memory to store the program which, when executed by the processor, performs
a recognition process for recognizing that the vehicle enters a boarding area where an occupant gets on or gets off,
a search process for searching for a guide in the boarding area when the vehicle enters the boarding area,
a selection process for, as an operation of the vehicle in the boarding area,
selecting a first operation mode when the guide is not found, and
selecting a second operation mode when the induction person is found, and
a process for mitigating a safety standard of an active safety system which avoids a collision between the vehicle and a surrounding object in the second operation mode, as compared with the first mode of operation.

2. The control device of the automated driving vehicle according to claim 1, wherein, the program, when executed by the processor, further performs a process for driving or stopping the vehicle in accordance with instruction information obtained from the guide in the second operation mode.

3. The control device of the automated driving vehicle according to claim 1, wherein the program, when executed by the processor, further performs a process for generating a target trajectory to cause the vehicle to follow the guide in the second operation mode.

4. The control device of the automated driving vehicle according to claim 1, wherein the program, when executed by the processor, further performs a process for reducing a limiting distance between the vehicle and a surrounding object at which the active safety system operates in the second operation mode, as compared to the first mode of operation.

5. The control device of the automated driving vehicle according to claim 1, wherein the program, when executed by the processor, further performs a process for reducing a time-to-collision for the active safety system to operate for to the surrounding object in the second operation mode, as compared with the first operation mode.

6. The control device of the automated driving vehicle according to claim 1, wherein the program, when executed by the processor, further performs a process for making, in the second operation mode, a limiting distance between the vehicle and the guide, at which the active safety system operates for the guide shorter than a limiting distance between the vehicle and objects other than the guide, at which the active safety system operates for the objects.

7. The control device of the automated driving vehicle according to claim 1, wherein the program, when executed by the processor, further performs a process for making, in the second operation mode, a time-to-collision for the active safety system to operate for the guide shorter than a time-to-collision for which the active safety system operates for objects other than the guide.

8. The control device of the automated driving vehicle according to claim 1, wherein the program, when executed by the processor, further performs a process for excluding the guide from objects for which the active safety system operates in the second operation mode.

9. The control device of the automated driving vehicle according to claim 1, wherein the program, when executed by the processor, further performs a process for obtaining an image of a person existing around the vehicle, and searching for the guide by an image recognition process for the image.

10. The control device of the automated driving vehicle according to claim 1, wherein the program, when executed by the processor, further performs a process for obtaining a voice emitted around the vehicle, and searching for the guide by a voice recognition process for the voice.

11. The control device of the automated driving vehicle according to claim 1, wherein the program, when executed by the processor, further performs a process for, as operation of the vehicle on departure from the boarding area,
selecting the first operation mode when the guide is not found, and
selecting the second operation mode when the guide is found.
